(19) United States
(12) Patent Application Publication
(10) Pub. No.: US 2005/0265609 A1
(43) Pub. Date: Dec. 1, 2005

(54) Optical disc apparatus

(75) Inventor: Tomomitsu Morishige, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/137,418

(22) Filed: May 26, 2005

(30) Foreign Application Priority Data
May 26, 2004 (JP) 2004-156703

(51) Int. Cl. G06K 9/36

(52) U.S. Cl. 382/235; 382/284

(57) ABSTRACT

In a screen saver image creation mode, a microprocessor reads, from a DVD placed on a tray, original data for a screen saver image and the contents of a text file having parameters specifying the background color, the motion, and the size of the screen saver image, and automatically creates the screen saver image by image editing based on the original data and the values of the parameters in the text file. Accordingly, a user can easily obtain a screen saver image that is truly unique.

### BACKGROUND OF THE INVENTION

1. Field of the Invention

The present invention relates to an optical disc apparatus for reproducing video signals and audio signals based on compressed data, e.g., of video and audio, stored in the storage area on an optical disc.

2. Description of the Related Art

Optical disc apparatus are known that, when no video signal is being reproduced based on compressed video data stored in the storage area on an optical disc and a predetermined time period has elapsed after last manipulation, output a screen saver image to a television receiver so as to protect the display components of the television receiver. However, such a conventional optical disc apparatus can only use default images prestored as screen saver images in a memory in the apparatus. In other words, the conventional apparatus fails to output a user desired screen saver image to a monitor, like a personal computer.

In view of the above problem, an optical disc apparatus disclosed in Japanese laid-open patent publication 2001-285804 is configured to store images read from e.g. optical discs in an external storage device or the like and use the stored images as screen saver images. Further, an image reproducing apparatus disclosed in Japanese registered utility model 3073272 can create unique images including screen saver images based on images being reproduced and on-screen data input from a user.

However, in the optical disc apparatus disclosed in Japanese laid-open patent publication 2001-285804, a user needs to perform complicated operations for editing of an screen saver image by the use of a mouse and the like on a personal computer side in order to change the size, the background color, and the motion of the screen saver image and thus to make the screen saver image truly unique. The image reproducing apparatus disclosed in Japanese registered utility model 3073272 does not allow a user to freely change the size, the background color, and the motion of a screen saver image, thus failing to create a screen saver image that is truly original.

### SUMMARY OF THE INVENTION

An object of the present invention is to provide an optical disc apparatus allowing a user to freely change the size, the background color, and the motion of a screen saver image with simple operations, thereby being capable of easily creating a truly unique screen saver image.

According to a first aspect of the present invention, an optical disc apparatus comprises: an optical pickup for reading compressed video data and compressed audio data recorded in a recording area on an optical disc; a decoder for decoding the compressed video data and the compressed audio data read by the optical pickup to reproduce video signals and audio signals; a video output for outputting the video signals reproduced by the decoder; an audio output for outputting the audio signals reproduced by the decoder; a memory for storing a screen saver image created based on the video signals reproduced by the decoder; a microprocessor for controlling the optical pickup, the decoder, and the memory; and operating means for inputting commands, which include a playback command, a stop command, and a tray opening/closing command, to the microprocessor.

When the optical disc containing original data for the screen saver image and a text file having parameters for image editing is loaded, the microprocessor reads, by the optical pickup, the original data and contents of the text file having the image editing parameters from the optical disc, automatically creates the unique screen saver image by image editing based on the original data and values of the image editing parameters stored in the text file, and stores the created screen saver image in the memory.

When no video signal is being reproduced by the decoder and a predetermined time period has elapsed after a last operation by a user using the operating means, the microprocessor reads the screen saver image from the memory and outputs video signals corresponding to the read screen saver image through the video output.

By the above configuration, a user can freely change the size, the background color, and the motion of a screen saver image with simple operations, i.e., only by performing operations to write, on an optical disc, the original data for the screen saver image and the text file having the parameters specifying the background color, the motion, and the size of the screen saver image and then to cause the optical disc to be read by the optical pickup. Accordingly, a user can easily create a screen saver image that is truly unique.

Preferably, the optical disc apparatus further comprises a mode selection switch for switching the optical disc apparatus from a normal mode to a screen saver image creation mode, the normal mode being a mode in which the video signals and the audio signals reproduced by the decoder are output through the video output and the audio output without change, wherein, in the screen saver image creation mode, the microprocessor automatically creates the unique screen saver image by the image editing based on the original data and the values of the image editing parameters stored in the text file.

Further preferably, the image editing parameters are parameters specifying the background color, the motion, and the size, respectively, of the screen saver image.

According to a second aspect of the present invention, an optical disc apparatus comprises: data reading means for reading compressed video data and compressed audio data recorded in a recording area on an optical disc; decoding means for decoding the compressed video data and the compressed audio data read by the data reading means to reproduce video signals and audio signals; output means for outputting the video signals and the audio signals reproduced by the decoding means; storage means for storing a screen saver image created based on the video signals reproduced by the decoding means; control means for controlling the data reading means, the decoding means, and the storage means; and operating means for inputting commands, which include a playback command, a stop command, and a tray opening/closing command, to the control means.

When the optical disc containing original data for the screen saver image and a text file having parameters for image editing is loaded, the control means reads, by the data reading means, the original data and contents of the text file having the image editing parameters from the optical disc, automatically creates the unique screen saver image by image editing based on the original data and values of the image editing parameters stored in the text file, and stores the created screen saver image in the storage means.

When no video signal is being reproduced by the decoding means and a predetermined time period has elapsed after a last operation by a user using the operating means, the control means reads the screen saver image from the storage means and outputs video signals corresponding to the read screen saver image through the output means.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an electrical block diagram of an optical disc apparatus according to one embodiment of the present invention;

FIG. 2 is a flowchart showing a process executed in a screen saver creation mode in the optical disc apparatus;

FIG. 3 illustrates data in a text file to be read at the step S5 in FIG. 2;

FIG. 4 is a flowchart showing a screen saver image editing process executed at the step S6 in FIG. 2; and

FIG. 5 is a flowchart showing a screen saver image displaying process in the optical disc apparatus.

### DESCRIPTION OF THE PREFERRED EMBODIMENTS

Referring now to the accompanying drawings, the preferred embodiment of the present invention is described. The present invention relates to an optical disc apparatus that reproduces video signals and audio signals based on compressed data, e.g., of video and audio, stored in the storage area on an optical disc, and that allows unique screen saver images to be easily created. The specific embodiment described below is not intended to cover the entire scope of the present invention, and hence the present invention is not limited to only the specific embodiment.

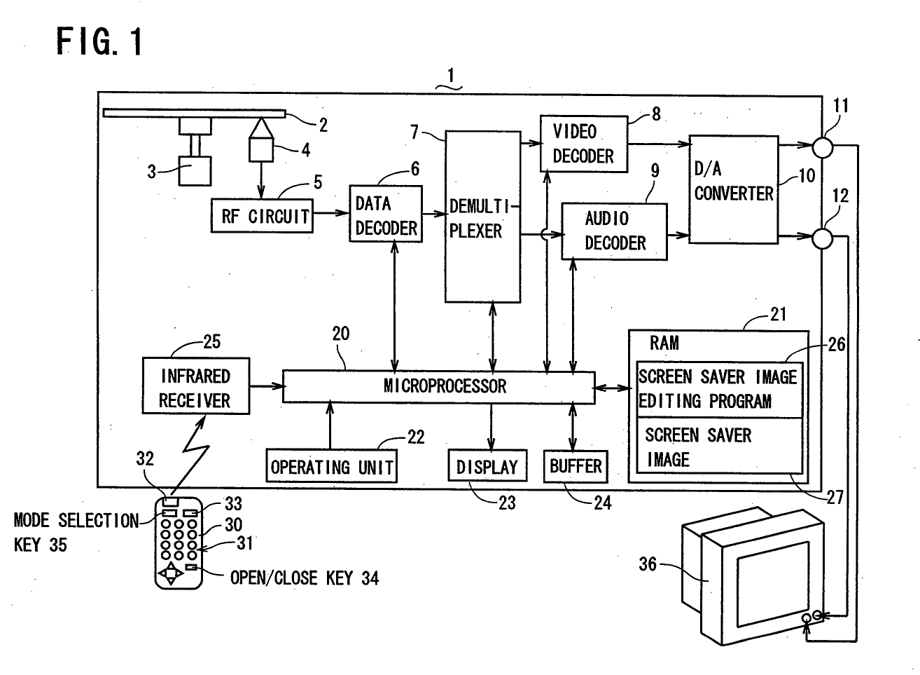

FIG. 1 is an electrical block diagram of an optical disc apparatus according to this embodiment. This optical disc apparatus 1 includes a spindle motor 3 to rotate a digital versatile disc (DVD) 2 placed on a tray, an optical pickup 4 (data reading means) to output data recorded on the DVD 2 in the form of RF signals, an RF circuit 5 to e.g. digitize the RF signals output from the optical pickup 4, and a data decoder 6 to execute data decode process including demodulation process and error-correct process to data processed by the RF circuit 5. The optical disc apparatus 1 further includes a demultiplexer 7 to demultiplex the data decoded by the data decoder 6 into compressed video data and compressed audio data, a video decoder 8 to decode the compressed video data, and an audio decoder 9 to decode the compressed audio data. Claimed decoder or decoding means mainly consists of the data decoder 6, the video decoder 8, and the audio decoder 9 described above.

A digital to analog (D/A) converter 10 shown in FIG. 1 converts digital video signals and digital audio signals decoded by the video decoder 8 and the audio decoder 9 into analog video signals and analog audio signals. A video output 11 and an audio output 12 output the video signals and the audio signals, respectively, sent from the D/A converter 10 to a liquid crystal display 36. The video output 11 and the audio output 12 correspond to claimed output means.

The optical disc apparatus 1 further includes a microprocessor 20 (control means) to control each component of the apparatus and a remote controller 30 to be used to input a command such as a playback command, a stop command or the like to the apparatus and to make various settings of the apparatus. The microprocessor 20 is connected to not only the data decoder 6, the demultiplexer 7, the video decoder 8, and the audio decoder 9 described above but also a RAM 21 (claimed memory or storage means) that stores a screen saver image editing program 26 (hereinafter referred to simply as “editing program”) and various data including a screen saver image 27, an operating unit 22 to be operated to input a command such as a playback command, a stop command or the like to the microprocessor 20, a display 23 to display various messages, a buffer 24 to temporarily store data such as resume data and the like, and an infrared receiver 25 to receive infrared signals transmitted from the remote controller 30. The remote controller 30 and the operating unit 22 correspond to claimed operating means.

The above described remote controller 30 has a key portion 31 including various keys and an infrared transmitter 32. Disposed at the key portion 31 are not only a power key 33, numeric keys, and cursor keys but also an open/close key 34 for a user to input a command to open or close the tray to the microprocessor 20, a mode selection key 35 (claimed mode selection switch or mode selection means) to switch the apparatus between modes. Modes selectable by the mode selection key 35 include a normal mode in which video signals and audio signals reproduced by the video decoder 8 and the-audio decoder 9 are output, as they are, through the video output 11 and the audio output 12 and a screen saver image creation mode (referred to, hereinafter, as “screen saver creation mode”).

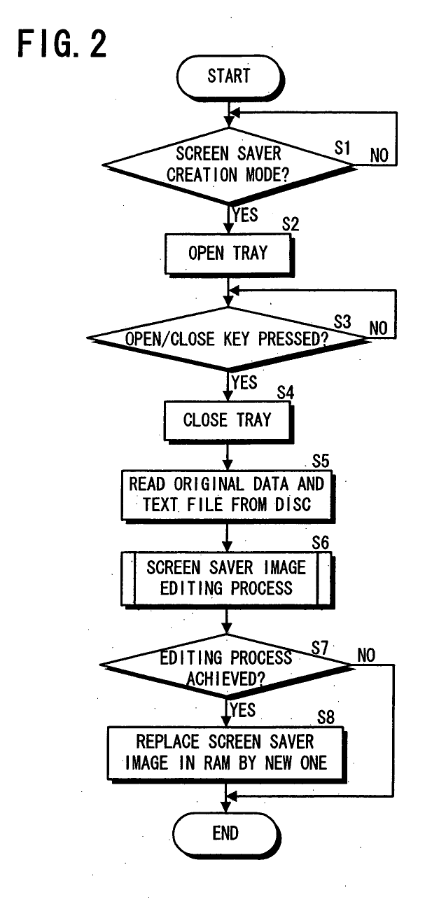

Referring now to the flowchart of FIG. 2, the process executed by the optical disc apparatus 1 in the screen saver creation mode is described. In the normal mode, when a user presses the mode selection key 35 on the remote controller 30, the microprocessor 20 switches the apparatus to the screen saver creation mode (YES at S1) and opens the tray not shown (S2). Next, the user places on the tray the DVD 2 containing original data for a screen saver image and a text file having parameters specifying the background color, the motion, and the size of the screen saver image, and presses the open/close key 34 on the remote controller 30 (YES at S3). Then, the microprocessor 20 closes the tray (S4) and reads the original data and the contents of the text file having the parameters specifying the background color, the motion, and the size of the screen saver image (S5). Subsequently, the microprocessor 20 transfers the original data for the screen saver image along with the parameters in the text file to the editing program 26 and thereafter executes the editing program 26 so as to perform image editing for creation of the screen saver image (S6).

If the editing is achieved (YES at S7), the microprocessor 20 replaces the screen saver image 27 in the RAM 21 by the screen saver image newly created through the above described editing process (S8).

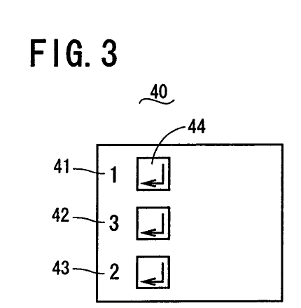

Referring now to FIG. 3, a description is made as to the data in the text file. Stored on the first line in the text file 40 are a first parameter 41, which is a parameter specifying the background color of the screen saver image, and a linefeed code 44. For example, when the value of the first parameter 41 is “1”, “2”, or “3”, the liquid crystal display 36 displays black, blue, or green color as the background color. Stored on the second line in the text file 40 are a second parameter 42, which is a parameter specifying the motion of the screen saver image, and a linefeed code 44. For example, when the value of the second parameter 42 is “1”, the screen saver image moves from left to right, when the value is “2”, the screen saver image remains at rest, and when the value is “3”, the screen saver image rotates in a circular motion. Stored on the third line in the text file 40 are a third parameter 43, which is a parameter specifying the size of the screen saver image, and a linefeed code 44. For example, when the value of the third parameter 43 is “1”, “2”, or “3”, the screen saver image is displayed in full-screen size, half size, or one-quarter size on the liquid crystal display 36. It is to be noted that a user can enter the first to third parameters 41 to 43 and the linefeed codes 44 in the text file 40 by using an editor, e.g., the WordPad.

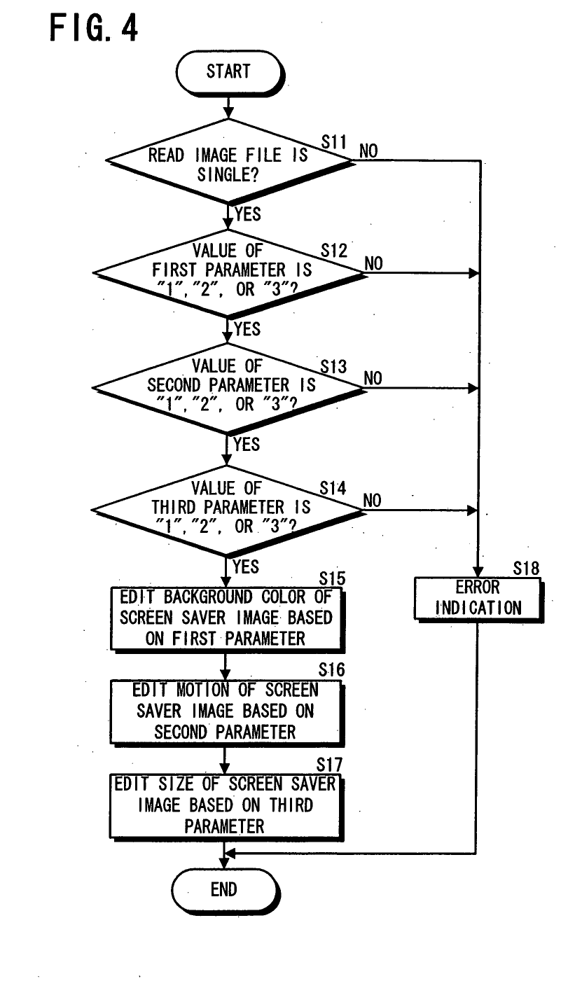

Referring now to the flowchart of FIG. 4 along with FIG. 3 described above, the screen saver image editing process at the step S6 in FIG. 2 is described in more detail. If the number of image file(s) (as original data for screen saver images) read at the step S5 in FIG. 2 is one (YES at S11), and the size of the single image file does not exceed a predetermined value stored in the RAM 21, and all of the values of the first to third parameters 41 to 43 shown in FIG. 3 are any one of “1”, “2”, and “3” (YES at all of the steps S12 to S14), the microprocessor 20 executes the process of editing the background color, the motion, and the size of the screen saver image. More particularly, the microprocessor 20 edits the background color of the screen saver image based on the value of the first parameter 41 shown in FIG. 3 (S15). Further, the microprocessor 20 edits the motion of the screen saver image based on the value of the second parameter 42 (S16). Moreover, the microprocessor 20 edits the size of the screen saver image based on the value of the third parameter 43 (S17). On the other hand, if the number of image file(s) read at the step S5 in FIG. 2 is not one (No at S11), or the size of the read image file exceeds the predetermined value stored in the RAM 21, or at least one of the values of the first to third parameters 41 to 43 shown in FIG. 3 is anything other than “1”, “2”, and “3” (NO at any one of the steps S12 to S14), the microprocessor 20 performs an error indication processing (S18) and exits the process. It is to be noted that the microprocessor 20 executes the process of the steps S11 to S18 in accordance with instructions stored in the editing program 26.

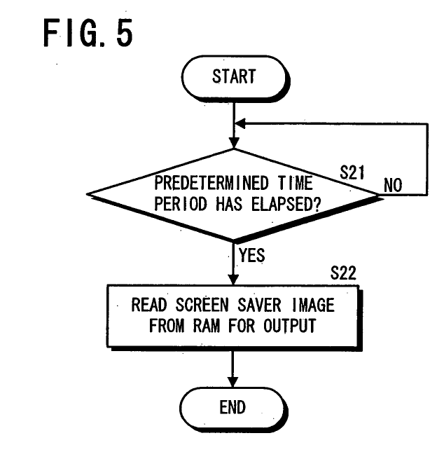

Referring now to the flowchart of FIG. 5, the process of displaying a screen saver image in the optical disc apparatus 1 is described. When no video signal is being reproduced based on compressed video data stored in the storage area on the DVD 2 by e.g. the optical pickup 4 and the video decoder 8 shown in FIG. 1, and a predetermined time period has elapsed after a last operation by a user using the remote controller 30 or the operating unit 22 (YES at S21), the microprocessor 20 reads the screen saver image 27 from the RAM 21. Then, the microprocessor 20 outputs video signals corresponding to the read screen saver image 27 through the video output 11 to the liquid crystal display 36 (S22).

As described above, the optical disc apparatus 1 according to this embodiment is configured to read, from the DVD 2, the original data for the screen saver image and the contents of the text file 40 having the parameters specifying the background color, the motion, and the size of the screen saver image, and creates the unique screen saver image by the image editing based on the original data and the values of the first to third parameters 41 to 43 in the text file 40. By this configuration, a user can freely change the size, the background color, and the motion of the screen saver image simply by performing an operation to write, on the DVD 2, the original data for the screen saver image and the text file 40 having the parameters specifying the background color, the motion, and the size of the screen saver image before placing the DVD 2 on the tray in the screen saver image creation mode. Accordingly, a user can easily create a screen saver image that is truly unique.

The present invention has been described above using a presently preferred embodiment, but those skilled in the art will appreciate that various modifications are possible. Accordingly, all such modifications are intended to be included within the spirit and scope of the present invention. For example, in the above embodiment, the remote controller 30 is provided with the mode selection key 35 so that, when a user presses the mode selection key 35 in the normal mode, the microprocessor 20 switches the apparatus into the screen saver creation mode. However, it is also possible to write an identification code as a disc for use in creation of a screen saver in management information storage area on a DVD containing original data for a screen saver image along with a text file so that the microprocessor can read the identification code from the DVD to automatically switch the apparatus into the screen saver creation mode. In addition, image editing parameters to be stored in a text file for creation of a screen saver image are not limited to the parameters specifying the background color, the motion, and the size of the image. Further, the present invention can be applied to optical disc apparatus such as a DVD recorder, a CD player, or the like as well as a DVD player.

This application is based on Japanese patent application 2004-156703 filed May 26, 2004, the contents of which are hereby incorporated by reference.

1. An optical disc apparatus comprising:
an optical pickup for reading compressed video data and compressed audio data recorded in a recording area on an optical disc;
a decoder for decoding the compressed video data and the compressed audio data read by the optical pickup to reproduce video signals and audio signals;
a video output for outputting the video signals reproduced by the decoder;
an audio output for outputting the audio signals reproduced by the decoder;
a memory for storing a screen saver image created based on the video signals reproduced by the decoder;
a microprocessor for controlling the optical pickup, the decoder, and the memory; and
operating means for inputting commands, which include a playback command, a stop command, and a tray opening/closing command, to the microprocessor,
wherein when the optical disc containing original data for the screen saver image and a text file having parameters for image editing is loaded, the microprocessor reads, by the optical pickup, the original data and contents of the text file having the image editing parameters from the optical disc, automatically creates the unique screen saver image by image editing based on the original data and values of the image editing parameters stored in the text file, and stores the created screen saver image in the memory; and
wherein when no video signal is being reproduced by the decoder and a predetermined time period has elapsed after a last operation by a user using the operating means, the microprocessor reads the screen saver image from the memory and outputs video signals corresponding to the read screen saver image through the video output.

2. The optical disc apparatus according to claim 1, further comprising a mode selection switch for switching the optical disc apparatus from a normal mode to a screen saver image creation mode, the normal mode being a mode in which the video signals and the audio signals reproduced by the decoder are output through the video output and the audio output without change,
wherein, in the screen saver image creation mode, the microprocessor automatically creates the unique screen saver image by the image editing based on the original data and the values of the image editing parameters stored in the text file.

3. The optical disc apparatus according to claim 2, wherein the image editing parameters are parameters specifying a background color, a motion, and a size, respectively, of the screen saver image.

4. The optical disc apparatus according to claim 1, wherein the image editing parameters are parameters specifying a background color, a motion, and a size, respectively, of the screen saver image.

5. An optical disc apparatus comprising:
data reading means for reading compressed video data and compressed audio data recorded in a recording area on an optical disc;
decoding means for decoding the compressed video data and the compressed audio data read by the data reading means to reproduce video signals and audio signals;
output means for outputting the video signals and the audio signals reproduced by the decoding means;
storage means for storing a screen saver image created based on the video signals reproduced by the decoding means;
control means for controlling the data reading means, the decoding means, and the storage means; and
operating means for inputting commands, which include a playback command, a stop command, and a tray opening/closing command, to the control means,
wherein when the optical disc containing original data for the screen saver image and a text file having parameters for image editing is loaded, the control means reads, by the data reading means, the original data and contents of the text file having the image editing parameters from the optical disc, automatically creates the unique screen saver image by image editing based on the original data and values of the image editing parameters stored in the text file, and stores the created screen saver image in the storage means; and
wherein when no video signal is being reproduced by the decoding means and a predetermined time period has elapsed after a last operation by a user using the operating means, the control means reads the screen saver image from the storage means and outputs video signals corresponding to the read screen saver image through the output means.

6. The optical disc apparatus according to claim 5, further comprising mode selection means for switching the optical disc apparatus from a normal mode to a screen saver image creation mode, the normal mode being a mode in which the video signals and the audio signals reproduced by the decoding means are output through the output means without change,
wherein, in the screen saver image creation mode, the control means automatically creates the unique screen saver image by the image editing based on the original data and the values of the image editing parameters stored in the text file.

7. The optical disc apparatus according to claim 6, wherein the image editing parameters are parameters specifying a background color, a motion, and a size, respectively, of the screen saver image.

8. The optical disc apparatus according to claim 5, wherein the image editing parameters are parameters specifying a background color, a motion, and a size, respectively, of the screen saver image.
